(19) United States
(12) Patent Application Publication
(10) Pub. No.: US 2014/0255093 A1
(43) Pub. Date: Sep. 11, 2014

(54) SIMPLE ENGAGING DEVICE

(71) Applicant: YA YUN YANG, Taichung City (TW)

(72) Inventor: YA YUN YANG, Taichung City (TW)

(21) Appl. No.: 13/786,797

(22) Filed: Mar. 6, 2013

(51) Int. Cl. F16B 5/07; F16B 12/44

(52) U.S. Cl. CPC F16B 5/07; F16B 12/44
USPC 403/382

(57) ABSTRACT

A simple engaging device includes a locating base with a pair of through hole sets being joined to the facial side of a flat piece of modular furniture, and two locating stems being joined to the lateral side of another flat piece; each of the through hole set has a first through hole and a second through hole with a flat engaging part disposed in between and the through holes communicating with each other laterally; each of the locating stems extends an engaging head with an annular recess in between corresponding to the flat locating part, and the engaging head is inserted into the first through hole and pushed toward the second through hole with the flat locating part engaging with the annular recess for the two flat pieces being easily assembled to each other perpendicularly.

### BACKGROUND OF THE INVENTION

1. Field of the Invention

The present invention relates to a simple engaging device, and more particularly to an engaging device capable of joining two flat pieces of modular furniture perpendicularly.

2. Description of Related Art

Currently, the engaging device for modular furniture available on the market is usually made of metal, plastics, or wood; the engaging device is attached to the flat pieces in advance with hand tools such as screw driver, pliers, and hammers before the flat pieces of the modular furniture are assembled. However, the user always meets following troubles during setting up the modular furniture:
1. It needs much time to realize and classify the engaging device in order to avoid mistakenly assembling the flat pieces.
2. The engaging device is made of plastics, wood, or metal, and it is needed to use the hand tools not only to fix the engaging device to the flat pieces but also to assemble the flat pieces; the assembling job for the modular furniture becomes hard or impossible to be done without the hand tools.
3. Mostly, the engaging device is designed to be incapable of disengaging from the plates after assembling; incorrect assembly may result in the modular furniture is unable to be set up completely.
4. If the user is not good at engineering drawings, identifying the various parts of the modular furniture with the parts drawings often perplex the user.

### SUMMARY OF THE INVENTION

In order to improve the preceding deficiencies of the prior art, the main objective of the present invention is to provide a simple engaging device which is small sized and mounted to the flat pieces of the modular furniture directly during the parts thereof being fabricated in the factory such that the simple engaging device does not interfere and hurt the flat pieces during packaging and delivering.

Another object of the present invention is to provide a simple engaging device which allows the modular furniture being set up completely in a short period of time without the hand tools.

### BRIEF DESCRIPTION OF THE DRAWINGS

Further benefits and advantages of the present invention will become apparent after a careful reading of the detailed description with appropriate reference to the accompanying drawings:

FIG. 1 is an exploded perspective view of an engaging device in accordance with the present invention;

FIG. 2 is a perspective view of the engaging device in accordance with the present invention.

### DETAILED DESCRIPTION OF THE INVENTION

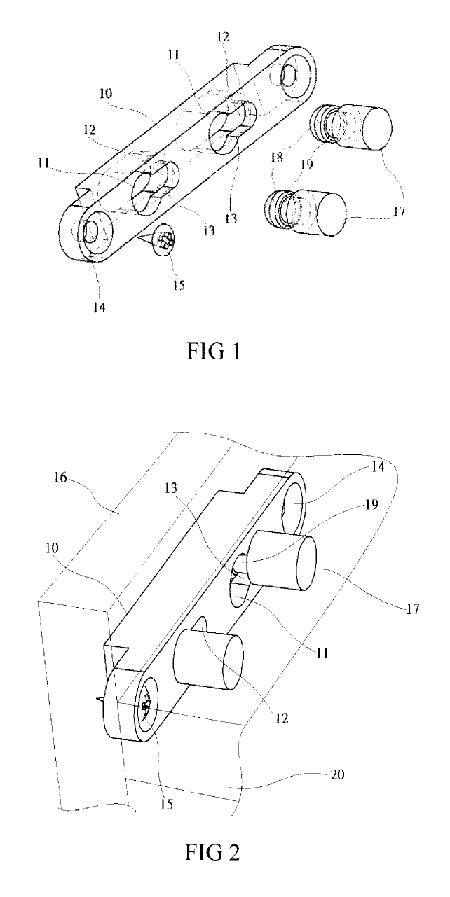

Referring to FIGS. 1 and 2, a preferred embodiment of the engaging device in accordance with the present invention basically has an elongated locating base 10 which is embedded in a flat piece 16 of modular furniture with the facial surface thereof being flush with the facial side of the flat piece 16. A pair of through hole sets spaces apart from each other and extends to the rear side of the locating base 10 from the facial side thereof; each of the through hole sets has a first through hole 11 and a reduced sized second through hole 12 disposed next to the first through hole 11 laterally, and the first through hole 11 communicates with the second through hole 12 laterally; in addition, a flat locating part 13 is disposed between the first and second through holes 11, 12. Both ends of the locating base 10 have a fixing hole 14 respectively for the locating base 10 being retained in the flat piece 16 with a screw 15 engaging to the fixing hole 14.

A pair of locating stems 17, which is corresponding to the through hole sets, is joined to a lateral side of another flat piece 20 of the modular furniture with an engaging head 18 extending outward the lateral side of the plate 20 respectively; a joining recess 19 is disposed between the engaging head 18 and the respective locating stem 17 corresponding to the flat locating part 13.

The locating base 10 and the locating stems 17 are fixed in the flat pieces 16, 20 during the flat pieces 16, 20 being fabricated; when the modular furniture is set up, the engaging head 18 is inserted into the first through hole 11 respectively and then pushed toward the second through hole 12 to allow the joining recess 19 engaging with the flat locating part 13; under the circumferences, the engaging head 18 and the locating stem 17 are retained at two opposite sides of the flat locating part 13 to allow the flat piece 16 being assembled to the flat piece 20 perpendicularly. In this way, the modular furniture can be set up sequentially and completely easily.

Although the invention has been explained in relation to its preferred embodiment, it is to be understood that many other possible modifications and variations can be made without departing from the spirit and scope of the invention as hereinafter claimed.

What is claimed is:

1. An engaging device for flat pieces of modular furniture comprising:
a locating base being embedded and fixed in a first one of the flat pieces from a facial side of said one of the plates, and having a facial surface flush with the facial side of said one of the plate and a pair of through hole sets;
two locating stems being embedded and fixed in another one of the flat pieces from a lateral side of said second one of the flat pieces to correspond to the through hole sets;
wherein each of the through hole sets has a first through hole, a second through hole disposed next to the first through hole laterally and being less in size comparing to the first through hole, and a flat locating part disposed between the first and second through holes, and the two through holes communicate with each other laterally;
wherein each of the locating stems extends outward an engaging head with an annular recess between the respective stem and the engaging head to correspond to the flat locating part to allow the engaging head being inserted into the first through hole and pushed laterally to the second through hole with the flat locating part engaging with the annular recess such that the first and second flat pieces are easily assembled to each other perpendicularly.
